(19) United States
(12) Patent Application Publication
(10) Pub. No.: US 2014/0283400 A1
(43) Pub. Date: Sep. 25, 2014

(54) Levelling Device

(71) Applicant: Luke LAMONT, North Lake, western Australia (AU)

(72) Inventors: Luke Lamont, North Lake (AU); Edward Joseph Khoury, Bateman (AU)

(21) Appl. No.: 14/358,040

(22) PCT Filed: Nov. 13, 2012
(86) PCT No.: PCT/AU2012/001396

§ 371 Date: May 14, 2014

(30) Foreign Application Priority Data
Nov. 14, 2011 (AU) 2011904727

(51) Int. Cl. G01C 9/28

(52) U.S. Cl. CPC G01C 9/28
USPC 33/379

(57) ABSTRACT

A levelling device (10) comprising a body portion (12) having one or more level indicators (14) mounted therein and a pair of electrical socket pins (28) extending outwardly from a first side of the body portion (12) arranged to be received in apertures (29) provided in a power socket of a wall plate (26).

### FIELD OF THE INVENTION

The present invention relates to a device for levelling wall mounted plates including power sockets and light switches.

### BACKGROUND TO THE INVENTION

A variety of wall mounted plates are used for different purposes in buildings. Electrical equipment, for example. commonly uses wall mounted plates such as light switches and power sockets. These plates are affixed to the wall using conventional means, such as screws received through apertures in the plate.

It is desirable with such wall mounted plates to ensure that the edges of the plates are oriented level. In order to achieve this accurately, devices such as spirit levels may be used. However, some wall plates do not have straight edges against which the level can be held. Also, in many situations an installer may simply set the orientation of the plate by eye due to the inconvenience of using a conventional spirit level. Any resulting tilt in the wall mounted plate results in an unsatisfactory appearance.

The present invention relates to a device provided for levelling a wall mounted plate, such as an electrical wall plate, which is aimed at being easy and convenient to use.

### SUMMARY OF THE INVENTION

According to one aspect of the present invention there is provided a levelling device comprising a body portion having one or more level indicators mounted and a pair of electrical socket pins extending outwardly from a first side thereof to be received in apertures provided in a power socket.

Preferably first and second level indicators are provided, each comprising a spirit level tube wherein the first spirit level tube is oriented to be perpendicular to the second spirit level tube.

In a preferred embodiment, the body portion is generally elongate in shape and the electrical socket pins are provided extending generally outwardly from adjacent a midpoint thereof.

In a preferred embodiment, there is provided a pair of cylindrical lugs located adjacent opposed ends of the body portion for engaging with apertures in a wall plate for receiving securing screws.

Preferably the tugs extend outwardly from a second side of the body portion, the second side being opposite the first side.

Preferably the lugs are hollow and openings are provided in the body portion extending from the first side surface through to the interior of the lugs such that a screwdriver may be passed through the openings from the first side surface and out of the centre of the lugs to secure a wall plate engaged with the levelling device.

In a preferred embodiment, a pair of studs is provided extending outwardly from the body for engaging with apertures in a mounting block.

Preferably the studs extend outwardly from the first side of the body portion such that a first of the studs is adjacent the first end of the body portion and a second of the studs is adjacent the second end of the body portion.

Preferably the studs are received in holes in the body portion such that outer ends thereof extend beyond the body portion and inner ends are contained within the holes and wherein the studs are spring biased such that the studs may be pushed inwardly into the holes but will move back outwardly from the holes when released.

In one embodiment, the spring bias is provided by springs provided within the holes in engagement with inner ends of the studs.

In one embodiment, the body portion comprises first and second parallel side members and first and second end members wherein the first end member joins the first and second side members adjacent first ends thereof and the second end member joins the first and second side members adjacent second ends thereof.

Preferably a central member is provided extending generally between a midpoint of the first side member and a midpoint of the second side member such that a first opening is defined between the first end member and the central member a second opening is defined between the second end member and the central member, the first level indicator being provided in the first opening and the second level indicator being provided in the second opening.

Preferably the electrical socket pins are located on the central member, the first cylindrical lugs and the first studs are located on the first end member and the second cylindrical lugs and the second studs are located on the second end member.

In a preferred embodiment, the first and second side members are provided with indents midway along the outer surfaces thereof for gripping the body portion.

Preferably the indents and the ends of the first and second end members are provided with ribbing to aid holding of the body portion between the fingers.

### BRIEF DESCRIPTION OF THE DRAWINGS

The invention will now be described, by way of example, with reference to the following drawings, in which:

FIG. 1a is a first upper perspective view of a levelling device in accordance with the present invention;

FIG. 1b is a second upper perspective view of the levelling device of FIG. 1a;

FIG. 2a is a front view of the levelling device of FIG. 1;

FIG. 2b is a rear view of the levelling device of FIG. 1;

FIG. 3a is a side view of the levelling device of FIG. 1;

FIG. 3b is a top view of the levelling device of FIG. 1;

FIG. 4 is an exploded view of the levelling device of FIG. 1;

FIG. 5a is an upper perspective view of the levelling device of FIG. 1 prior to engagement with a power socket;

FIG. 5b is a side view of the levelling device of FIG. 1 prior to engagement with the power socket;

FIG. 5c is a side view of the levelling device of FIG. 1 engaged with the power socket;

FIG. 5d is a front view of the levelling device of FIG. 1 engaged with the power socket;

FIG. 5e is a side cross sectional view of the levelling device of FIG. 1 engaged with the power socket;

FIG. 5f is a close up view of Detail A of FIG. 5e;

FIG. 6a is an upper perspective view of the levelling device of FIG. 1 prior to engagement with a light switch;

FIG. 6b is a front view of the levelling device of FIG. 1 engaged with the light switch;

FIG. 6c is an upper perspective view of the levelling device of FIG. 1 engaged with the light switch showing tightening of the switch plate securing screws;

FIG. 6d is a top view of the levelling device of FIG. 1 engaged with the light switch showing tightening of the switch plate securing screws;

FIG. 7a is an upper perspective view of the levelling device of FIG. 1 prior to engagement with an alternative light switch;

FIG. 7b is a top view of the levelling device of FIG. 1 engaged with the light switch of FIG. 7a;

FIG. 7c is a front view of the levelling device of FIG. 1 engaged with the light switch of FIG. 7a;

FIG. 8a is an upper perspective view of the levelling device of FIG. 1 prior to engagement with a mounting plate;

FIG. 8b is a top view of the levelling device of FIG. 1 prior to engagement with the mounting plate of FIG. 8a;

FIG. 8c is a front view of the levelling device of FIG. 1 engaged with the mounting plate of FIG. 8a;

FIG. 9a is an upper perspective view of the levelling device of FIG. 1 prior to engagement with an alternative mounting plate; and

FIG. 9b is a front view of the levelling device of FIG. 1 engaged with the mounting plate of FIG. 9a.

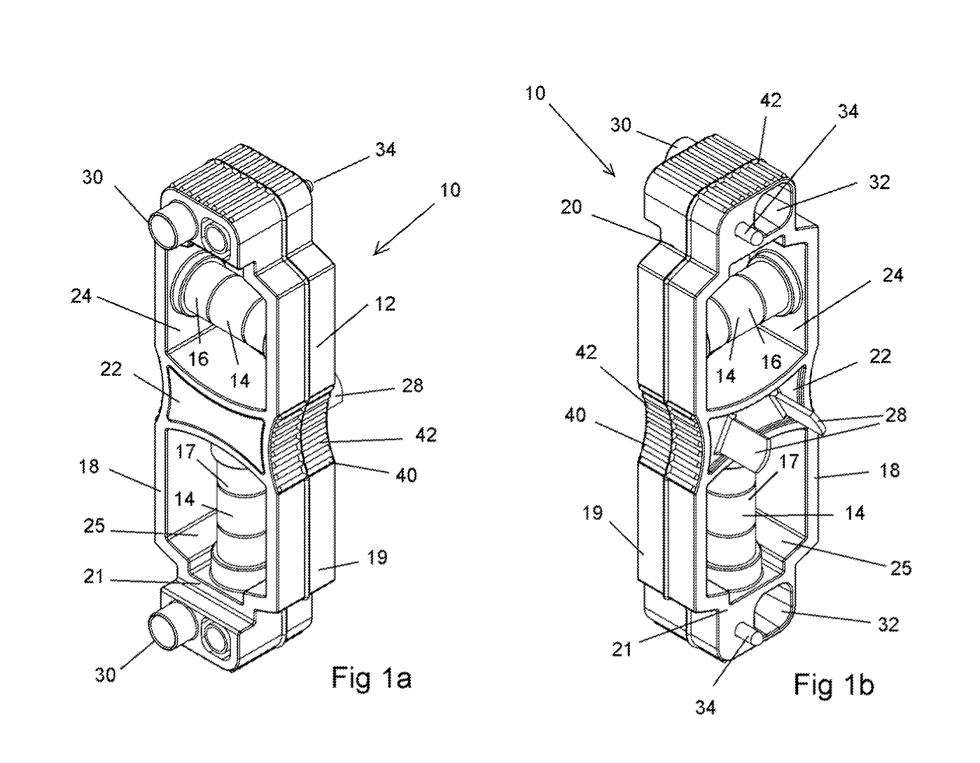

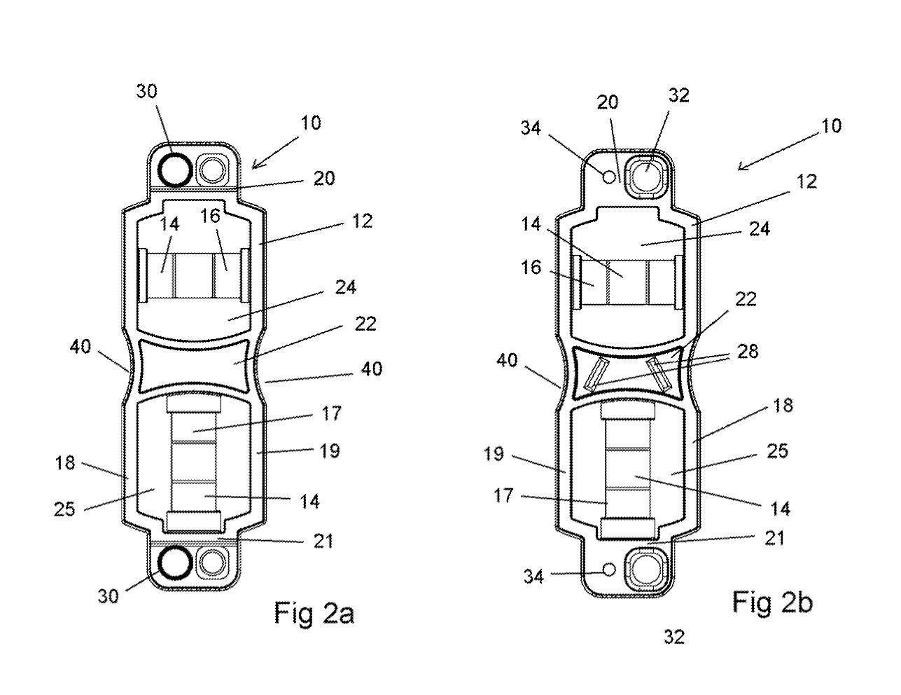

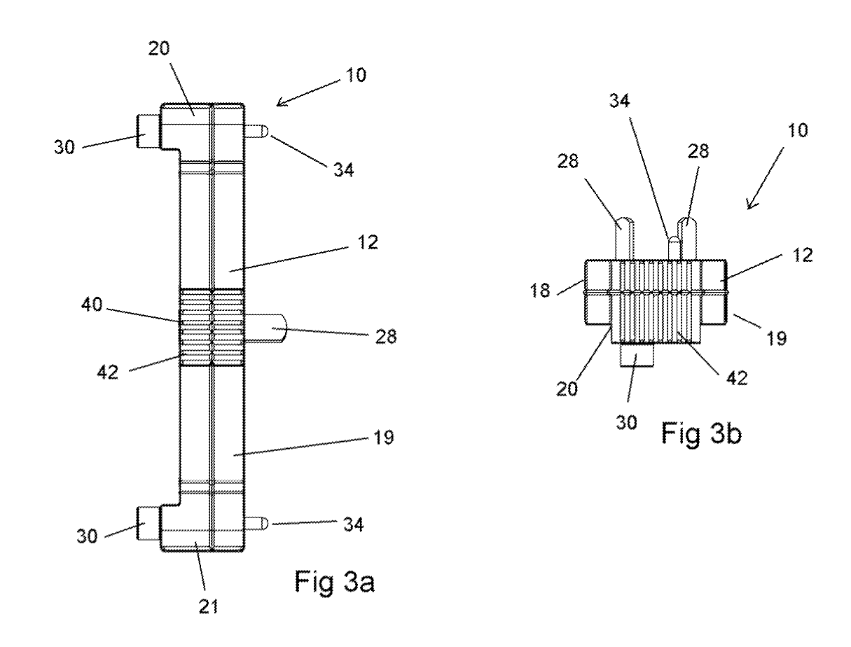

### DETAILED DESCRIPTION OF PREFERRED EMBODIMENTS

Referring to Figures, there is shown a levelling device 10 comprising a body portion 12 having one or more level indicators 14 mounted therein. In the embodiment shown, there is provided a first level indicator 16 and a second level indicator 17. Each of the first and second level indicators 16 and 17 comprise a spirit level tube. The first and second spirit level tubes are arranged perpendicular to each other to provide an indication of whether the body portion 12 is level in either the horizontal or vertical orientation.

In the embodiment shown, the body portion 12 comprises first and second parallel side members 18 and 19 and first and second end members 20 and 21. The first end member 20 joins the first and second side members 18 and 19 adjacent first ends thereof and the second end member 21 joins the first and second side members 18 and 19 adjacent second ends thereof. There is also provided a central member 22 which extends generally between a midpoint of the first side member 18 and a midpoint of the second side member 19.

The body portion 12 is therefore generally elongate in shape, being rectangular, and includes a first opening 24 defined between the first end member 20 and the central member 22 and a second opening 25 defined between the central member 22 and the second end member 21. The first level indicator 16 is provided in the first opening 24 and the second level indicator 17 is provided in the second opening 25. The first level indicator 16 extends between the first and second side members 18 and 19 and the second level indicator 17 extends between the central member 22 and the second end member 21.

The levelling device 16 is provided with one or more sets of protrusions provided for engaging with apertures in a wall plate 26. The apertures in the wail plate 26 may comprise the apertures provided for receiving securing screws, or the apertures in a socket type plate provided for receiving the pins of a power plug in use.

In the embodiment shown, the body portion 12 of the levelling device 10 is provided with a first set of protrusions on a first side surface thereof comprising a pair of electrical socket pins 28. The electrical socket pins 26 are provided to be received in apertures 29 of a power socket provided on the wall plate 26. In the embodiment shown, the electrical socket pins 28 comprise the angled fiat pins used as the active and neutral pins for Australian electrical sockets. It will be appreciated however that the electrical socket pins 28 may comprise alternative shapes for fitting into power sockets used in other countries. The electrical socket pins 28 extend from the central member 22 such that the electrical socket pins 28 extend outwardly from adjacent a midpoint of the elongate body portion 12.

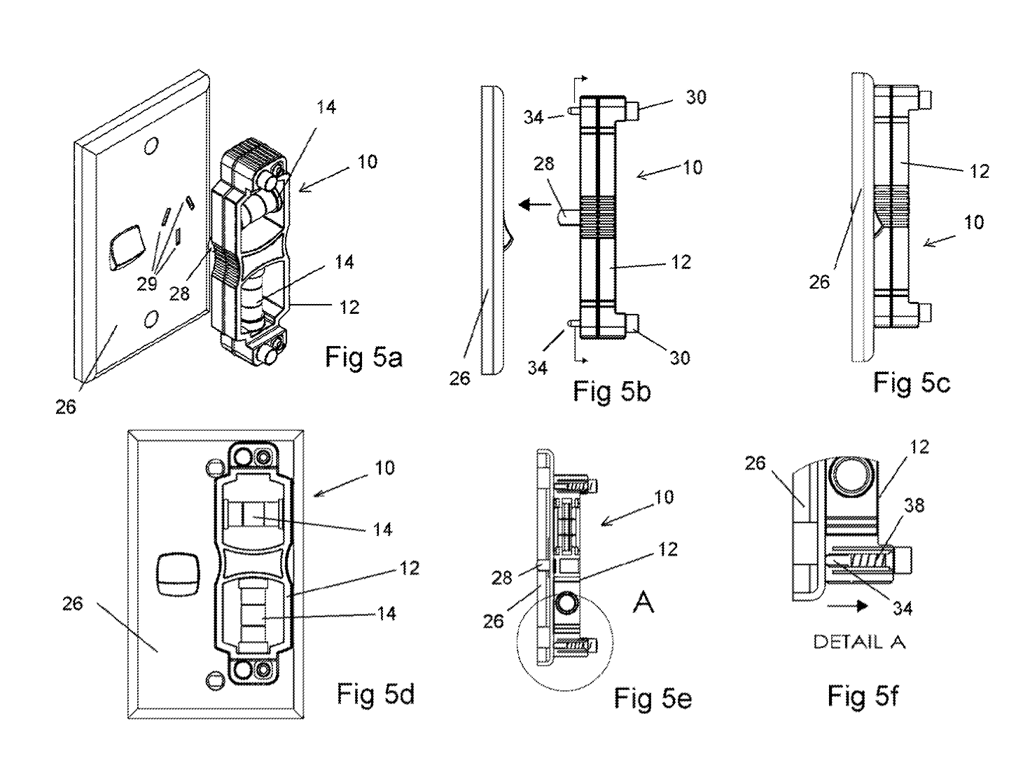

In the embodiment shown, the electrical socket pins 28 are oriented such that when the electrical socket pins 28 are received in the apertures 29 of the power socket (as shown in FIG. 5), the first and second side members 18 and 19 are generally vertical. The first level indicator 16 can therefore provide an indication of whether the wall plate 26 is level.

The levelling device 10 is also provided with a second set of protrusions comprising a pair of lugs 30 on a second side of the body portion 12, the second side being opposite the first side thereof. A first of the lugs 30 is provided adjacent a first end of the body portion 12 and a second of the lugs 30 is provided adjacent a second remote end of the body portion 12. That is, the first and second lugs 30 are provided adjacent either end of the body portion 12 with the electrical socket pins 28 located generally between the lugs 30.

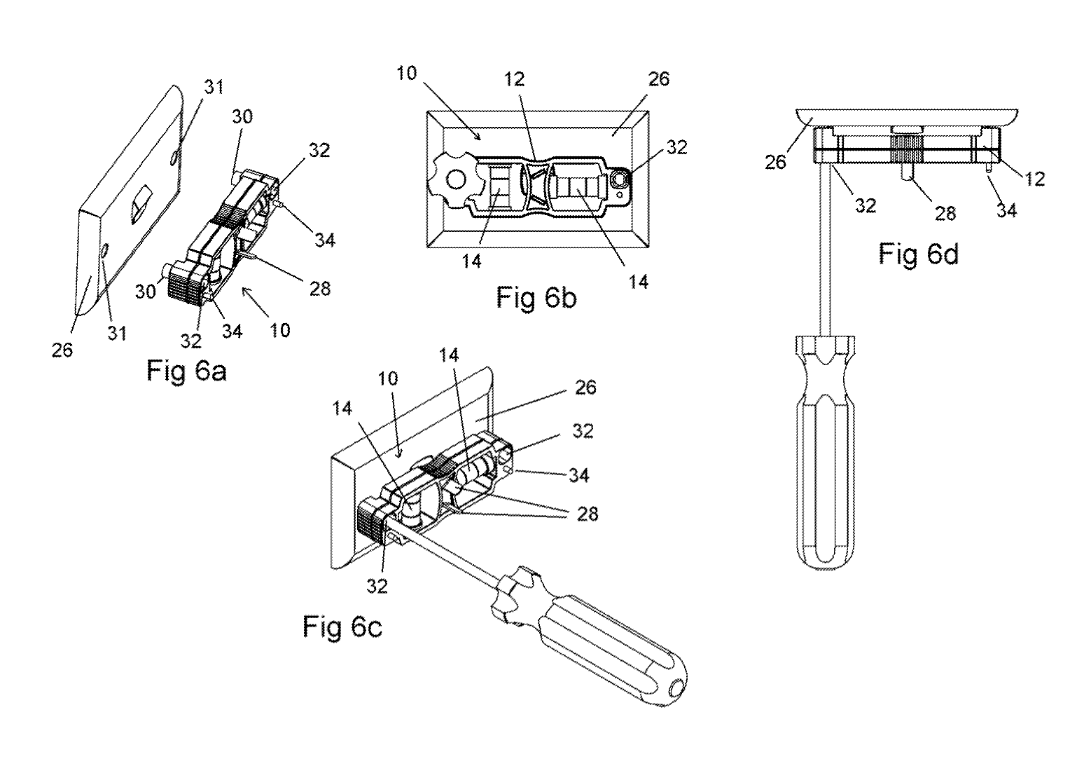

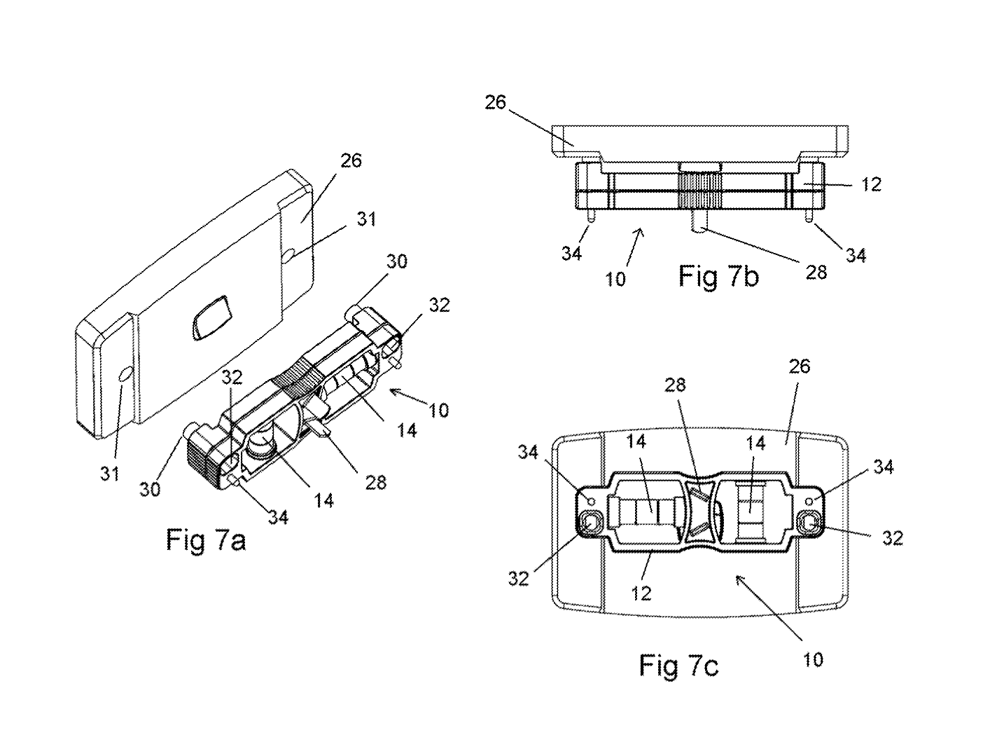

The lugs 30 are generally cylindrical in shape. A first of the lugs 30 is provided on the first end member 20 and second of the lugs 30 is provided on the second end member 21. Each of the lugs 30 is sized to be received in an aperture 31 in the wall plate 26 that would be used to receive a securing screw. The distance between the lugs 30 is set to be equivalent to the standard distance between the apertures 31 of a standard wall plate 26. The lugs 30 are arranged such that a line extending between the protrusions 30 is parallel to the first and second side members 18 and 19. Therefore, when the lugs 30 are received in the apertures 31 of a wall plate 26, such as a switch plate (as shown in FIG. 6), the level indicators 14 provide an indication of whether the wall plate 26 is level.

The lugs 30 are hollow and openings 32 are provided in the body portion 12 such that the openings 32 align with the interior of the lugs 30. The openings 32 extend from the first side surface of the body portion 12 through to the interior of the lugs 30 such that a screwdriver may be passed through the openings 32 from the first side surface and out of the centre of the lugs 30. As can be seen in FIG. 6, this allows the levelling device 10 to be engaged with the wall plate 26 and screws of the wall plate 26 may be tightened with the levelling device 10 remaining in place (as shown in FIGS. 6c and 6d) to indicate that the wall plate 26 is level.

The levelling device 10 is also provided with a set of third protrusions comprising a pair of studs 34 extending outwardly from the first side of the body portion 12. The studs 34 are also provided on the body portion 12 such that a first of the studs 34 is adjacent the first end of the body portion 12 and a second of the studs 34 is adjacent the second end of the body portion 12.

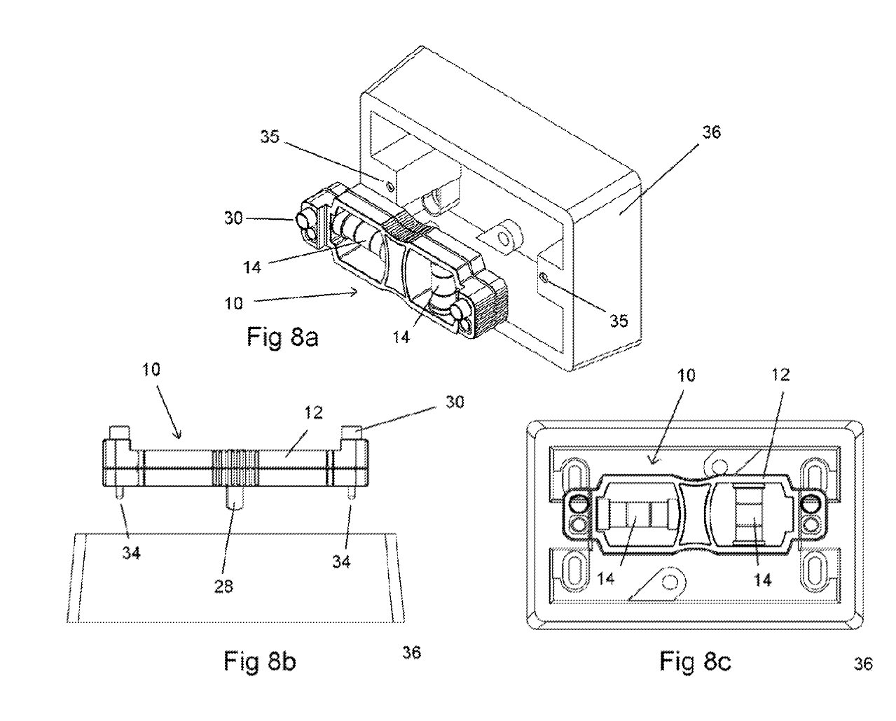

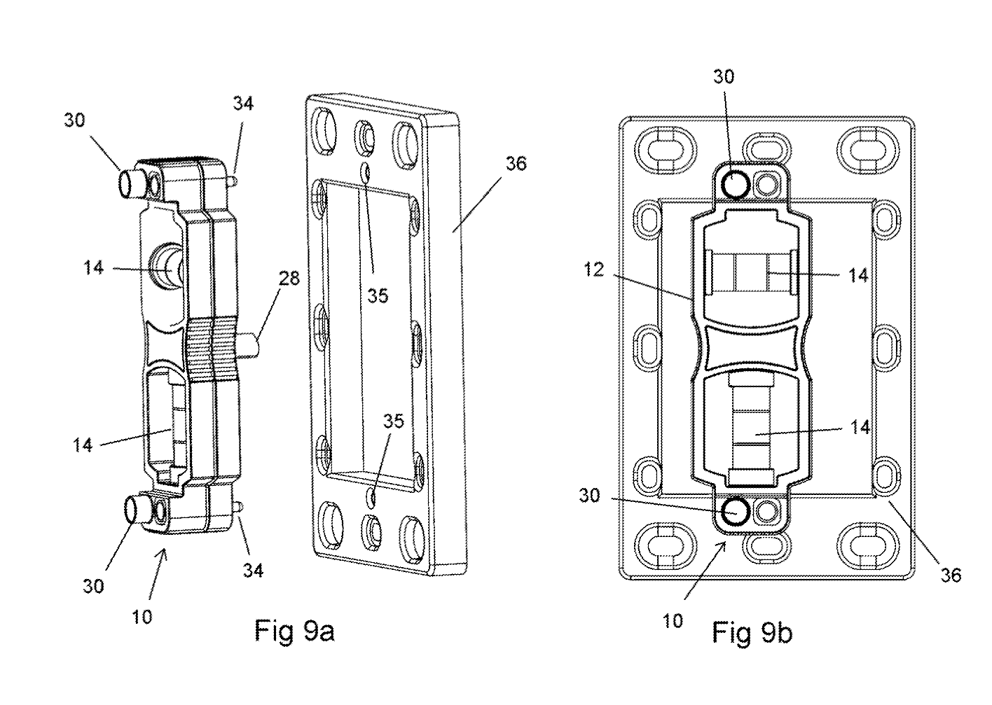

The first and second studs 34 are provided on the first and second end members 20 and 21 respectively. As can be seen in FIGS. 8 and 9, the studs 34 are provided to be received in apertures 35 of a mounting block 36 on which a wall plate 26 may be mounted. The studs 34 are locatable in the apertures 35 such that the levelling device 10 provides an indication of whether the mounting block 36 is level, in the same manner as for the wall plate 26.

The studs 34 are received in holes 37 in the body portion 12 such that outer ends thereof extend beyond the body portion 12 and inner ends are contained within the holes 37. The studs 34 may be pushed inwardly into the holes but are spring biased such that the studs 34 will move back outwardly from the holes 37 when released. The spring bias is provided by springs 38 provided within the holes 37 in engagement with inner ends of the studs 34 such that pressing the studs 34 into the holes 37 compresses the springs 38. This arrangement is provided such that when the pins 28 are located in a power socket, the studs 34 can push back into the body portion 12 so they do not damage or mark the wall plate 26.

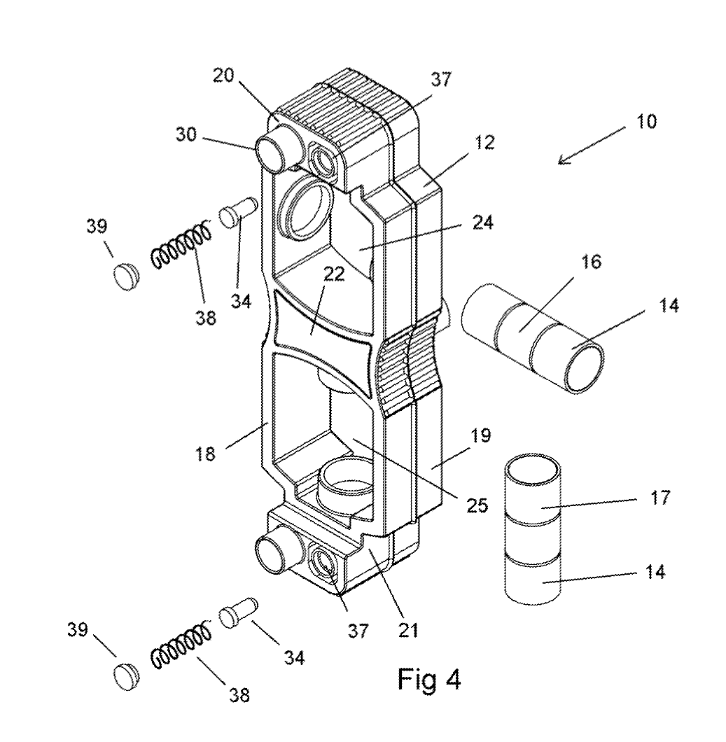

The studs 34 and the springs 38 may be received in the holes 37 from the second side surface of the body portion 12 (as shown in FIG. 4) and secured in place by caps 39 which seal across the holes 37 adjacent the second side surface.

The first and second side members 18 and 19 are also provided with indents 40 midway along the outer surfaces thereof. The indents 40 are provided with ribbing 42 so that the body portion 12 may be easily gripped by placing fingers into the indents 40. The ends of the first and second end members 20 and 21 are also provided with ribbing 42 to aid holding of the body portion 12 between the fingers by the end members 20 and 21.

It will be readily apparent to persons skilled in the relevant arts that various modifications and improvements may be made to the foregoing embodiments, in addition to those already described, without departing from the basic inventive concepts of the present invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A levelling device comprising:
a body portion having one or more level indicators;
a pair of electrical socket pins extending outwardly from a first side of the body portion; and
a pair of cylindrical lugs extending outwardly from a second opposite side of the body portion, the cylindrical lugs being hollow and comprising openings extending through the body portion to the first side thereof;
wherein the electrical socket pins are receivable in apertures provided in a power socket, and wherein the cylindrical lugs are engageable with apertures in a wall plate for receiving securing screws such that a screwdriver may be passed through the openings from the first side surface to engage with and tighten the securing screws.

15. The levelling device in accordance with claim 14, wherein first and second level indicators are provided, each comprising a spirit level tube, wherein a first spirit level tube is oriented to be perpendicular to a second spirit level tube.

16. The levelling device in accordance with claim 15, wherein the body portion is generally elongate in shape and the electrical socket pins are provided extending generally outwardly from adjacent a midpoint thereof.

17. The levelling device in accordance with claim 16, wherein the cylindrical lugs are located adjacent opposed ends of the body portion.

18. The levelling device in accordance with claim 17, wherein a pair of studs is provided extending outwardly from the body portion for engaging with apertures in a mounting block.

19. The levelling device in accordance with claim 18, wherein the studs extend outwardly from the first side of the body portion such that a first of the studs is adjacent the first end of the body portion and a second of the studs is adjacent the second end of the body portion.

20. The levelling device in accordance with claim 19, wherein the studs are received in holes in the body portion such that outer ends thereof extend beyond the body portion and inner ends are contained within the holes, and wherein the studs are spring biased such that the studs may be pushed inwardly into the holes but will move back outwardly from the holes when released.

21. The levelling device in accordance with claim 20, wherein a spring bias is provided by springs provided within the holes in engagement with inner ends of the studs.

22. The levelling device in accordance with claim 21, wherein the body portion comprises first and second parallel side members and first and second end members, wherein the first end member joins the first and second side members adjacent first ends thereof and the second end member joins the first and second side members adjacent second ends thereof.

23. The levelling device in accordance with claim 22, wherein a central member is provided extending generally between a midpoint of the first side member and a midpoint of the second side member such that a first opening is defined between the first end member and the central member, and a second opening is defined between the second end member and the central member, the first level indicator being provided in the first opening and the second level indicator being provided in the second opening.

24. The levelling device in accordance with claim 23, wherein the electrical socket pins are located on the central member, and wherein the first cylindrical lugs and the first studs are located on the first end member and the second cylindrical lugs and the second studs are located on the second end member.

25. The levelling device in accordance with any one of claim 24, wherein the first and second side members are provided with indents midway along the outer surfaces thereof for gripping the body portion.

26. The levelling device in accordance with claim 25, wherein the indents and the ends of the first and second end members are provided with ribbing to aid holding of the body portion between the fingers.
